(19) United States
(12) Patent Application Publication
(10) Pub. No.: US 2010/0109305 A1
(43) Pub. Date: May 6, 2010

(54) Airbag and airbag apparatus

(75) Inventor: Shuichiro Miyata, Minato-ku (JP)

Correspondence Address: FOLEY AND LARDNER LLP;SUITE 500, 3000 K STREET NW, WASHINGTON, DC, 20007, US

(73) Assignee: Takata Corporation

(21) Appl. No.: 12/588,796

(22) Filed: Oct. 28, 2009

(30) Foreign Application Priority Data
Nov. 4, 2008 (JP) 2008-283791
Sep. 4, 2009 (JP) 2009-205218

(51) Int. Cl. B60R 21/16

(52) U.S. Cl. 280/743.1; 280/728.1

(57) ABSTRACT

An airbag and an airbag apparatus that allows the smooth inflation and deployment of an airbag while preventing the airbag cover from removing off. The airbag apparatus includes an airbag that is normally in a folded state and inflates and deploys in the event of an emergency, an inflator that supplies gas to the airbag, a retainer for housing the airbag, and an airbag cover that locks the retainer thereto and constitutes a vehicle interior. The airbag is formed by applying a sealing compound to between base cloths, facing each other and sewing the sealing compound applied portions with sewing threads for joining the base cloths. The sealing compound has fracture elongation of more than 2000% and cohesive failure rate of 100%.

### BACKGROUND

The present disclosure relates to airbags and airbag apparatuses disposed in motor vehicles and the like, and more specifically, it relates to an airbag and an airbag apparatus that allows a sealing compound coating to be made thinner.

Motor vehicles such as passenger cars are typically provided with an airbag apparatus that inflates and deploys an airbag thereof for restraining an occupant in the passenger compartment in the event of an emergency, such as a collision.

The airbag used in these airbag apparatuses is a bag that is normally in a folded state and inflates and deploys in the event of an emergency. The airbag is formed by sewing a plurality of panels (base cloths) into the shape of a bag. Sewn portions formed on the circumference of the airbag maintain an inner pressure, and are therefore sealed with a sealing compound to prevent gas leakage.

A sealing compound, for example, described in Japanese Patent Application No. 3983096 has fracture elongation of 800% or more (preferably 1000 to 1500%) and is applied in a coating thickness of 0.3 to 1.5 mm. A sealing compound described in Japanese Unexamined Patent Application Publication No. 2006-327521 has fracture elongation of 1400% or more (preferably 1500 to 2000%) and is applied in a coating thickness of 0.3 to 1.5 mm. Furthermore, a sealing compound described in Japanese Unexamined Patent Application Publication No. 2005-313877 has fracture elongation of 600% or more (1700% or less in an embodiment) and is applied in a coating thickness of 0.05 to 1.0 mm.

Sealing compounds described above experience problems, such as (1) the use of a large amount of sealing compounds which results in an increase in cost and weight, (2) a thicker sealing compound coating which results in an increase in package volume after the airbag is folded, (3) a thicker sealing compound coating which results in difficulties in folding the airbag due to stiff sealed portions, (4) a higher sealing compound strength which exceeds the adhesion force of the sealing compound, causing tendency of the sealing compound to become unstuck, and (5) just thinning the coating thickness of a sealing compound resulting in gas leakage due to inability to withstand an increase in inner pressure which results from the inflation and deployment of the airbag. For known sealing compounds having fracture elongation of 2000% or less, the limit of coating thickness is approximately 0.3 mm.

It would be advantageous to provide an airbag and an airbag apparatus that allows a sealing compound coating to be made thinner.

### SUMMARY

According to a disclosed embodiment an airbag includes a pair of base cloths and a sealing compound located between the base cloths. The sealing compound contacts a portion of each of the base cloths. The base cloths are sewn together at the portions of the base cloths in contact with the sealing compound to thereby join the base cloths together. The sealing compound has fracture elongation of more than 2000% and the sealing compound has a cohesive failure rate of 100%.

According to another disclosed embodiment an airbag apparatus is provided. The airbag apparatus includes an airbag that is normally in a folded state and inflates and deploys in the event of an emergency, and an inflator for supplying gas to the airbag. The airbag includes a pair of base cloths and a sealing compound located between the base cloths and wherein the sealing compound contacts a portion of each of the base cloths. The base cloths are sewn together at the portions of the base cloths in contact with the sealing compound to thereby join the base cloths together. The sealing compound has fracture elongation of more than 2000% and the sealing compound has a cohesive failure rate of 100%.

According to another disclosed embodiment a method of forming an airbag is provided. The method includes the steps of providing a pair of base cloths; applying a sealing compound having a fracture elongation of more than 2000% and a cohesive failure rate of 100% to at least a portion of one of the base cloths; and sewing the base cloths together through the portion of the base cloth applied with the sealing compound to thereby join the base cloths together and form the airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIGS. 1(A)-1(D) are diagrams showing how a sealed portion fractures. FIG. 1(A) shows a state before a sealing compound begins to elongate. FIG. 1(B) shows a state where a sealing compound begins to elongate. FIG. 1(C) shows a state where a sealing compound begins to fracture. FIG. 1(D) shows a state where gas leakage occurs.

FIG. 2 is a diagram showing the relationship between fracture elongation s and coating thickness d of the sealing compound.

FIGS. 3(A)-3(D) are diagrams showing how a sealed portion of the airbag according to an exemplary embodiment behaves. FIG. 3(A) shows a state before a sealing compound begins to elongate. FIG. 3(B) shows a state where a sealing compound begins to elongate. FIG. 3(C) shows a state where a sealing compound begins to fracture. FIG. 3(D) shows a state immediately before gas leakage occurs.

FIG. 4 is a diagram showing the relationship between fracture elongation and fracture reaching load for Embodiment 1 and Embodiment 2.

FIG. 5 is a diagram showing the relationship between fracture elongation and fracture reaching load for Embodiment 3 and Embodiment 4.

FIG. 6 is a diagram showing an example of an airbag apparatus according to an exemplary embodiment. FIG. 6(A) shows a curtain airbag apparatus. FIG. 6(B) shows a side airbag apparatus.

FIG. 7 is a diagram showing an example of an airbag. FIG. 7(A) shows an airbag of a curtain airbag apparatus. FIG. 7(B) shows an airbag of a side airbag apparatus.

### DETAILED DESCRIPTION

Many types of airbag apparatuses have been developed and equipped as such an airbag apparatus, which include a driver side airbag apparatus disposed in the steering wheel, a passenger side airbag apparatus disposed inside of the instrument panel, a curtain airbag apparatus disposed inside the side of the vehicle, a side airbag apparatus disposed in the vehicle seat, a knee airbag apparatus disposed under the dash board, and the like.

The airbag used in these airbag apparatuses is a bag that is normally in a folded state and inflates and deploys in the event of an emergency. The airbag is formed by sewing together a plurality of panels (base cloths). Sewn portions formed on the circumference of the airbag maintain an inner pressure, and are therefore sealed with a sealing compound to prevent gas leakage. According to an exemplary embodiment, an airbag is formed by applying a sealing compound between base cloths proximate to the sewn portions, the sealing compound having fracture elongation of more than 2000% and cohesive failure rate of 100%.

According to another exemplary embodiment, an airbag apparatus includes an airbag that is formed by sewing together a plurality of panels (base cloths). According to an exemplary embodiment, an airbag is formed by applying a sealing compound between base cloths proximate to the sewn portions, the sealing compound having fracture elongation of more than 2000% and cohesive failure rate of 100%.

In the airbag and the airbag apparatus, the sealing compound has fracture reaching load of, for example, not less than 73 N/cm and not more than 219 N/cm. In the case where the base cloth has a thread size of 470 dtex, the sealing compound may have fracture reaching load of not less than 73 N/cm and not more than 158 N/cm, and in the case where the base cloth has a thread size of 235 dtex, the sealing compound may have fracture reaching load of not less than 93 N/cm and not more than 219 N/cm. Decitex (dtex) refers to the size or fineness of the thread (e.g., the mass (in grams) per 10000 meters of a single thread).

Further, the sealing compound has fracture elongation of not less than 2700% and not more than 4170%. In the case where the base cloth has a thread size of 470 dtex, the sealing compound may have fracture elongation of not less than 2700% and not more than 3960%, and where the base cloth has a thread size of 235 dtex, the sealing compound may have fracture elongation of not less than 2800% and not more than 4170%.

According to an exemplary embodiment, the sealing compound may have a coating thickness between 0.2 mm and 0.3 mm, a tensile strength of 1.0 MPa or less, a peel strength of 20 N/cm or less, and a hardness (pursuant to JIS Type A) of less than 10.

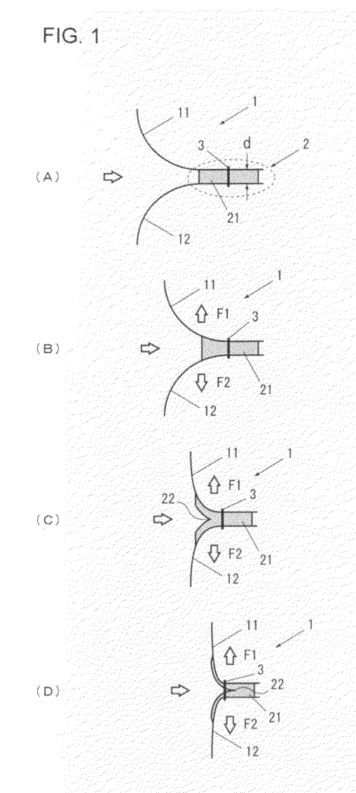

FIGS. 1(A) to 1(D) show how a sealed portion fractures. FIG. 1(A) shows a state before a sealing compound begins to elongate. FIG. 1(B) shows a state where a sealing compound begins to elongate. FIG. 1(C) shows a state where a sealing compound begins to fracture. FIG. 1(D) shows a state where gas leakage occurs. As shown in FIGS. 1(A)-1(D), an airbag 1 is formed by applying a sealing compound 21 to between base cloths 11, 12. The base cloths 11, 12 are sewn together with a sewing thread 3 proximate to the sealing compound 21 applied portions (sealed portion 2). First, a mechanism responsible for fracture of the sealed portion 2 of the airbag 1 is described below.

As shown in FIG. 1(A), even when the airbag 1 begins to inflate and deploy, the sealing compound 21 maintains a coating thickness d and keeps the base cloths 11, 12 sealed before the sealing compound 21 begins to elongate. As shown in FIG. 1(B), as the inflation and deployment of the airbag 1 progress, the base cloths 11, 12 progressively have tensile forces F1, F2 occurring so as to act in the direction in which the base cloths separate from each other. At this time, a relationship that the adhesion force (peel strength) of the sealing compound 21 is greater than the tensile forces F1, F2 is established, and the sealing compound 21 elongates so as to follow the base cloths 11, 12. As shown in FIG. 1(C), as the inflation and deployment of the airbag 1 further progress, the tensile forces F1, F2 acting on the base cloths 11, 12 increase. If the tensile forces F1, F2 exceed a certain level while the relationship that the adhesion force (peel strength) of the sealing compound 21 is greater than the tensile forces F1, F2 is kept, the sealing compound 21 begins to fracture. The tip of the fracture is termed a fracture point 22.

When a fractured area in the sealing compound layer is termed cohesive failure area and a fractured area in the interfaces between the sealing compound and the base cloths 11, 12 is termed an interfacial failure area. A cohesive failure rate (CF rate) is a rate determined by multiplying the cohesive failure area by 100 and dividing by the sum of the interfacial failure area and the cohesive failure area. A CF rate of 100% means that a fracture occurs in the sealing compound layer only. A CF rate of 100% is preferable, when the inner pressure maintaining performance of the airbag 1 is taken into account.

As shown in FIG. 1(D), as the inflation and deployment of the airbag 1 further progress, the fracture point 22 goes beyond the sewing thread 3, which causes fracture of the sealing compound 21 to reach the sewing thread 3, resulting in gas leakage from the sealed portions 2 (sewn portions).

Although such a mechanism has long been known, physical properties required for the sealing compound 21 have been thought to be the followings from the mechanism. First, it has been thought that the adhesion force (peel strength) of the sealing compound 21 should be greater than the tensile forces F1, F2 since when the adhesion force (peel strength) of the sealing compound 21 is smaller than the tensile forces F1, F2 the sealing compound 21 peels off from the base cloths 11, 12. Second, it has been thought that the sealing compound 21 should be as resistant as possible to fracture since the sealing compound 21 may cause gas leakage if it is easy to fracture. In other words, its tensile strength should be high enough to resist tensile forces F1, F2.

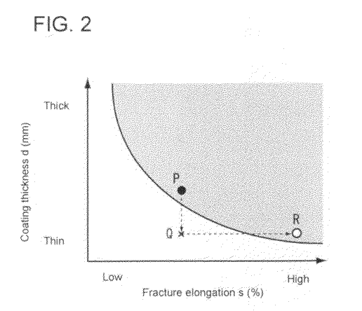

FIG. 2 is a diagram showing the relationship between fracture elongation s and coating thickness d of the sealing compound. In this figure, the abscissa represents fracture elongation s (%), while the ordinate represents coating thickness d (mm). As shown in FIG. 2, fracture elongation s is inversely proportional to coating thickness d in the sealing compound 21, meaning that the upper portion (shaded portions) of the graph is a usable region for the sealing compound 21. The relationship between fracture elongation s and coating thickness d of known sealing compounds 21 is represented by point P. In the case of the known sealing compound 21, if an attempt is made to reduce the coating thickness d with the fracture elongation s kept unchanged, such a usable region for the sealing compound 21 is exceeded, as depicted by point Q. Accordingly, if an attempt is made to attain a smaller coating thickness d than that of the known sealing compound 21, the fracture elongation s needs to be heightened, as depicted by point R. The sealing compound 21 according to an exemplary embodiment has the relationship represented by point R between fracture elongation s and coating thickness d.

The conditions for tensile strength as described above (e.g., tensile strength should be high enough to resist tensile forces F1, F2) mean that contraction force of the sealing compound 21 that resists tensile forces F1, F2 acting on the base cloths 11, 12 increases, which inevitably causes the adhesion force (peel strength) of the sealing compound 21 to increase. Accordingly, the known sealing compounds 21 have limitations on elongation due to their high peel strength and tensile strength, which compels the fracture elongation to be set to 2000% or less. Also, high peel strength and tensile strength have impacts on the hardness of the sealing compound 21, which causes the sealing compound 21 to have a certain level of hardness and results in difficulties in folding the airbag 1.

Consequently, as a result of an earnest study on a mechanism responsible for fracture of the sealing compound 21, it has been found that the strength (peel strength and tensile strength) of the sealing compound 21 itself is less necessary than has long been thought since the sealed portions 2 are sewn with the sewing threads 3. This results in achievement of an airbag that is resistant to gas leakage even if the sealing compound has fracture elongation set to 2000% or more.

In other words, the airbag 1 according to an exemplary embodiment is an airbag 1 formed by applying a sealing compound 21 to between base cloths 11, 12 facing each other and sewing the sealing compound 21 applied portions (sealed portion 2) for joining the base cloths 11, 12, wherein the sealing compound 21 has fracture elongation of more than 2000% and a cohesive fracture rate (CF rate) of 100%. The airbag and airbag apparatus disclosed herein allow the fracture elongation of the sealing compound 21 to be set to more than 2000%, thereby allowing a smaller coating thickness d to be achieved like a sealing compound 21 represented by point R in FIG. 2. Accordingly, the amount of sealing compound application can be reduced, leading to a reduction in cost and weight, ease of folding the airbag, and a reduction in an airbag package volume after the airbag is folded.

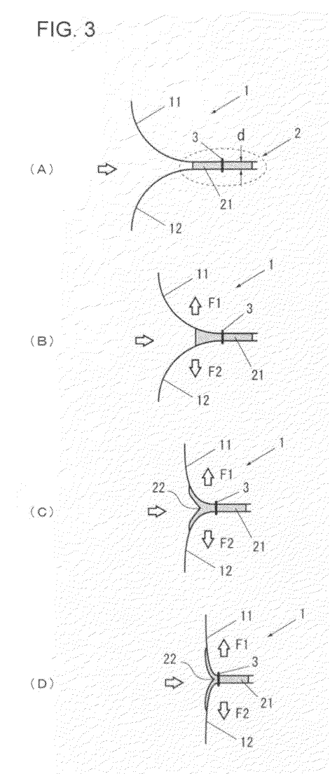

FIGS. 3(A)-3(D) is a diagram showing how an exemplary sealed portion of the airbag behaves. FIG. 3(A) shows a state before a sealing compound begins to elongate. FIG. 3(B) shows a state where a sealing compound begins to elongate. FIG. 3(C) shows a state where a sealing compound begins to fracture. FIG. 3(D) shows a state immediately before gas leakage occurs.

As shown in FIG. 3(A), according to an exemplary embodiment, the airbag 1 such that the coating thickness d is smaller than the coating thickness in known airbags 1, and, even when the airbag 1 begins to inflate and deploy, the sealing compound 21 maintains such a coating thickness d and keeps the base cloths 11, 12 sealed before the sealing compound 21 begins to elongate.

As shown in FIG. 3(B), as the inflation and deployment of the airbag 1 progress, the base cloths 11, 12 progressively have tensile forces F1, F2 acting in the direction in which the base cloths separate from each other. At this time, a relationship that the adhesion force (peel strength) of the sealing compound 21 is greater than the tensile forces F1, F2 is established, and the sealing compound 21 elongates, following the base cloths 11, 12.

As shown in FIG. 3(C), as the inflation and deployment of the airbag 1 further progress, the tensile forces F1, F2 acting on the base cloths 11, 12 increase. If the tensile forces F1, F2 exceed a certain level while the relationship that the adhesion force (peel strength) of the sealing compound 21 is greater than the tensile forces F1, F2 is kept, the sealing compound 21 begins to fracture while the CF rate remains at 100%. The tip of the fracture is named a fracture point 22.

As shown in FIG. 3(D), even in a state where the inflation and deployment of the airbag 1 further progress to such a degree that the known sealing compound 21 cannot withstand gas leakage, the airbag 1 according to an exemplary embodiment can retard the progress of the fracture point 22 and suppress gas leakage since the sealing compound 21 thereof has fracture elongation set to more than 2000% which makes the sealing compound 21 easily stretchable. This means that a smaller coating thickness d than that of the known sealing compound can be attained if the same sealing performance as that of the known sealing compound 21 suffices for the purpose and that better sealing performance than that of the known sealing compound 21 can be achieved if the same coating thickness d as that of the known sealing compound 21 suffices for this purpose.

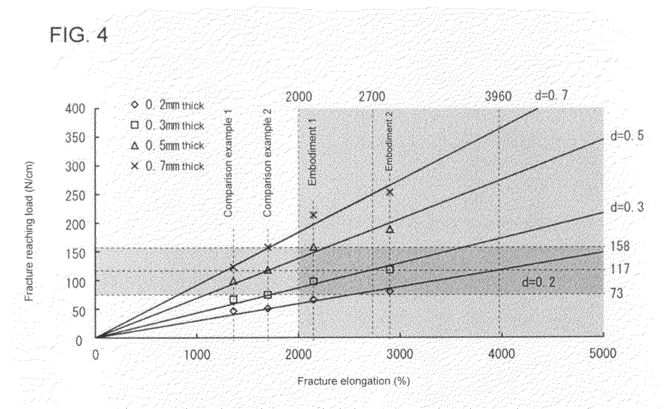

An exemplary embodiment of a coating is described in Table 1 and FIG. 4. Table 1 shows physical properties such as fracture elongation for Comparison Example 1 and Comparison Example 2, and Embodiment 1 and Embodiment 2. FIG. 4 is a diagram showing the relationship between fracture elongation and fracture reaching load for Embodiment 1 and Embodiment 2. Comparison Example 1 and Comparison Example 2 shown in Table 1 and FIG. 4 correspond to the known sealing compounds, while Embodiment 1 and Embodiment 2 correspond to the sealing compounds used in an exemplary embodiment. Cloths used in tests of Table 1 have a thread size of 470 dtex (decitex) and a weaving density (vertical by horizontal) of 46 by 46 (threads per inch). In FIG. 4, the abscissa represents fracture elongation (%), while the ordinate represents fracture reaching load (N/cm).

TABLE 1

| Physical | | | Comparison | Comparison | | |
|---|---|---|---|---|---|---|
| properties | Condition | Unit | Example 1 | Example 2 | Embodiment 1 | Embodiment 2 |
| Fracture | — | % | 1360 | 1700 | 2150 | 2900 |
| Elongation | | | | | | |
| Tensile | — | MPa | 3.0 | 2.6 | 0.8 | 0.4 |
| strength | | | | | | |
| Peel strength/ | 0.2 mm thick | N/cm | — | 17 | 13 | 8 |
| CF rate | | % | — | 100 | 100 | 100 |
| | 0.3 mm thick | N/cm | — | 26 | 20 | 13 |
| | | % | — | 100 | 100 | 100 |
| | 0.5 mm thick | N/cm | — | 49 | 34 | 19 |
| | | % | — | 100 | 100 | 100 |
| | 1.0 mm thick | N/cm | — | 64 | 45 | 24 |
| | | % | — | 100 | 100 | 100 |
| Hardness | JIS type A | — | 11 | 10 | 6 | 5 |
| Inner pressure | 0.3 mm thick | KPa | — | 5 | 69 | 85 |
| during static | | — | — | Yes | Yes | No |
| deployment | | | | | | |
| tests/gas | | | | | | |
| leakage | | | | | | |
| Fracture | 0.2 mm thick | N/cm | 47 | 51 | 66 | 81 |
| reaching load | 0.3 mm thick | N/cm | 67 | 75 | 98 | 118 |
| | 0.5 mm thick | N/cm | 100 | 118 | 158 | 189 |
| | 0.7 mm thick | N/cm | 123 | 158 | 214 | 254 |

“Fracture elongation” refers to a percentage (%) of an amount of elongation to the original length of a sealing compound at fracture. As shown in Table 1, fracture elongation for Comparison Example 1 is 1360% and fracture elongation for Comparison Example 2 is 1700%, which are less than 2000%. In contrast, fracture elongation for Embodiment 1 is 2150% and fracture elongation for Embodiment 2 is 2900%, which are set to more than 2000%.

“Tensile strength” refers to a maximum tensile stress (MPa) which acts on a sealing compound at fracture. Tensile strength for Comparison Example 1 and Comparison Example 2 is 3.0 MPa and 2.6 MPa, respectively, while tensile strength for Embodiment 1 and Embodiment 2 is 0.8 MPa and 0.4 MPa, respectively, which are set to less than 1.0 MPa. As described above, in Embodiment 1 and Embodiment 2 according to an exemplary embodiment, tensile strength is set to significantly lower levels than that of the known sealing compounds.

“Peel strength” refers to a force per unit width (N/cm) required to peel off a sealing compound from a base cloth in such a manner that the sealing compound is perpendicular to the surface of the base cloth. In peel tests, a base cloth of a predetermined size (for example, approximately 250 mm by 50 mm) was used as a specimen which was coated with a sealing compound in such a manner that the sealing compound coating had a width of approximately 10 to 15 mm and a predetermined thickness. Such a specimen was mounted on the chuck and was pulled at approximately 200 mm/m. Then, a load at which the sealing compound fractured was measured. At the same time, the CF rate (cohesive fracture rate) was also measured. These tests found that the peel strength of Comparison Example 2 was 17 N/cm, 26 N/cm, 49 N/cm, and 63 N/cm for coating thickness of 0.2 mm, 0.3 mm, 0.5 mm, and 1.0 mm, respectively. Since Comparison Examples 1 and 2 have substantially the same peel strength, tests on Comparison Example 1 was omitted.

In contrast, the peel strength of Embodiment 1 was 13 N/cm, 20 N/cm, 34 N/cm, and 45 N/cm for coating thicknesses of 0.2 mm, 0.3 mm, 0.5 mm, and 1.0 mm, respectively, while the peel strength of Embodiment 2 was 8 N/cm, 13 N/cm, 19 N/cm, and 24 N/cm. These test results show that greater fracture elongation results in lower peel strength for the same coating thickness of a sealing compound, while smaller coating thickness results in lower peel strength for the same fracture elongation. To achieve a smaller coating thickness for a sealing compound and because the known sealing compound has an average coating thickness of approximately 0.5 mm, it is preferable to use a sealing compound having peel strength equal to or less than that of Embodiment 1 (34 N/cm) for coating thickness of 0.5 mm. In addition, it is more preferable to use a sealing compound having peel strength equal to or lower than that of Embodiment 1 (20 N/cm) for a coating thickness of 0.3 mm. Also, assuming that further smaller coating thickness is possible, a sealing compound having peel strength equal to or less than that of Embodiment 1 (13 N/cm) for a coating thickness of 0.2 mm may be used. It was found that CF rate (cohesive fracture rate) was 100% throughout all the tests.

Tensile strength and peel strength described above are physical properties that affect the strength of a sealing compound. In order to have fracture elongation set to more than 2000%, a flexible sealing compound that can withstand the fracture elongation must be prepared by controlling either or both of the physical properties. More specifically, the tensile strength and peel strength must be controlled by repeatedly conducting simulations and tests so as to achieve a sealing compound having a desired coating thickness that can withstand fracture elongation of more than 2000%. The requirements derived from Embodiment 1 and Embodiment 2 described above that tensile strength should be 1.0 MPa or less and that peel strength should be not more than a predetermined value (for example, 34 N/cm, 20 N/cm, 13 N/cm) or less are provided only as an example.

“Hardness” refers to a measurement value obtained on the basis of testing methods pursuant to JIS-K6253 Type A. Since hardness is affected by the magnitude of the tensile strength and peel strength, higher strengths represent being harder, while lower strengths represent being softer. For example, Comparison Example 1, Comparison Example 2, Embodiment 1, and Embodiment 2 were found to have a hardness of 11, 10, 6, and 5, respectively. These measurement results show that a hardness of less than 10 is preferable.

“Inner pressure during static deployment test” refers to an inner pressure of an airbag measured three seconds after the inflator (gas generator) is initiated. Such a test for inner pressure during a static deployment used the specimen as used in the peel strength measurement, whose sealing compound applied portions are sewn with polyamide sewing threads. The sewing threads have a thread size of 1400 dtex with sewing pitches of 2.0 to 2.3 mm. For “gas leakage”, sealed portions (sewn portions) were inspected for presence of gas leakage at the time of the measurement of the inner pressure during static deployment tests. Comparison Example 2 had an inner pressure of 5 kPa during static deployment tests and suffered from gas leakage. In this Comparison Example 2, gas leakage was present all around the sealed portions, showing that the inner pressure of 5 kPa during static deployment tests is a lower limit. Accordingly, since it is obvious that Comparison Example 1 having lower fracture elongation than Comparison Example 2 also suffers from gas leakage all around the sealed portions like Comparison Example 2, testing on Comparison Example 1 was omitted. Inner pressure of 5 kPa during static deployment tests for Comparison Example 2 means that the inner pressure maintaining feature as an airbag is lost. In contrast, Embodiment 1 had an inner pressure of 69 kPa during static deployment tests, and Embodiment 2 had an inner pressure of 85 kPa during static deployment tests, showing that the inner pressure maintaining feature as an airbag is sufficiently secured. Although Embodiment 1 suffered from partial gas leakage, it provides satisfactory performance as an airbag because of its ability to maintain inner pressure at 69 kPa during static deployment tests.

As shown in Table 1, the known sealing compound (Comparison Examples 1 and 2) provides an insufficient inner pressure during static deployment tests if the coating thickness thereof is reduced to 0.3 mm, while the sealing compound (Embodiments 1 and 2) used in an exemplary embodiment can maintain a sufficient inner pressure during static deployment tests even if the coating thickness thereof is reduced to 0.3 mm.

“Fracture reaching load” refers to a load (N/cm) at which the fracture of a sealing compound reaches the sewing threads. The relationship between fracture reaching load and fracture elongation in Comparison Example 1, Comparison Example 2, Embodiment 1, and Embodiment 2 can be represented as shown in FIG. 4. In FIG. 4, consideration of the relationship between fracture elongation and fracture reaching load for each coating thickness d indicates that the fracture elongation is proportional to the fracture reaching load. As shown in the figure, a line can be drawn for each of d=0.2, d=0.3, d=0.5, and d=0.7.

Most average known sealing compounds are those having a coating thickness of 0.5 mm like Comparison Example 2. For the line of d=0.5, fracture reaching load of 117 N/cm can be found if the fracture elongation is 1700%. Also, when fracture reaching load is 117 N/cm, fracture elongation for the line of d=0.3 can be found to be 2700% and fracture elongation for the line of d=0.2 can be found to be 3960%. Accordingly, in order to ensure that a sealing compound having fracture elongation of more than 2000% used in an exemplary embodiment provides the same performance as that of the most average known sealing compounds, its fracture elongation may be set to not less than 2700% and not more than 3960%.

The known sealing compound typically has a coating thickness d of 0.3 mm or more. The same performance as the fracture reaching load (73 to 158 N/cm) found from FIG. 4 within the range of coating thickness d between 0.3 and 0.7 mm at fracture elongation (1700%) of Embodiment 2 allows for smaller coating thickness of a sealing compound.

Accordingly, it is preferable that a sealing compound for use in an airbag according to an exemplary embodiment is a sealing compound which meets a region (indicated by dark shades) in FIG. 4 where shaded portions in which fracture elongation is more than 2000% and shaded portions in which fracture reaching load is between 73 and 158 N/cm overlap. Although smaller coating thickness d results in better sealing compounds, the coating thickness of not less than 0.2 mm and not more than 0.3 mm is preferable from a practical viewpoint, taking into account the coating process and application accuracy of a sealing compound. According to some exemplary embodiments, a sealing compound having coating thickness d of less than 0.2 mm may be used.

Fracture elongation and fracture reaching load values found from FIG. 4 described above are values that are variable depending upon experimental value errors, subtraction in approximate formulas or the like, and are not limited to the values described above. Accordingly, in order to ensure that the sealing compound according to an exemplary embodiment provides the same performance as the known sealing compounds, for example, fracture elongation may be set to a range between 2700% and 4000%, and fracture reaching load may be set to a range between 70 and 160 N/cm.

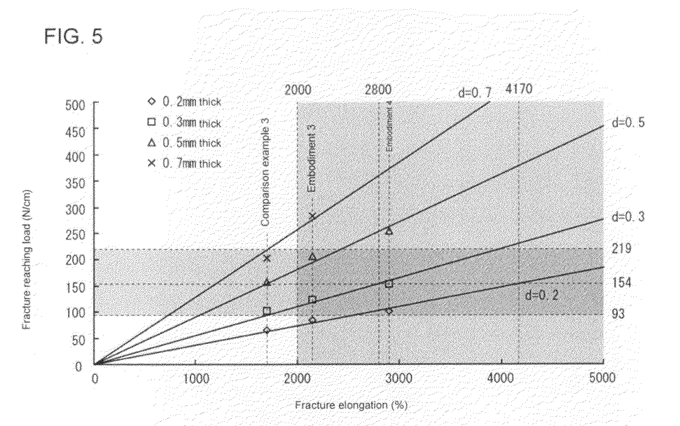

A sealing compound according to an exemplary embodiment is described on the basis of Table 2 and FIG. 5. Table 2 shows physical properties such as fracture elongation for Comparison Example 3 and Embodiment 3 and Embodiment 4. FIG. 5 is a diagram showing the relationship between fracture elongation and fracture reaching load for Embodiment 3 and Embodiment 4. Comparison Example 3 shown in Table 2 and FIG. 5 corresponds to the known sealing compounds, while Embodiment 3 and Embodiment 4 correspond to the sealing compounds used in an exemplary embodiment. Cloths used in tests of Table 2 have a thread size of 235 dtex (decitex) and a weaving density (vertical by horizontal) of 70 by 70 (threads per inch). Such cloths have a thread size that is half of that of the base cloth used in Embodiment 1 and Embodiment 2, and are often used in airbags in which air tightness, light weight, and reduced package size are sought. Threads constituting a base cloth employ polyamide fibers, like those used in all examples in Table 1.

TABLE 2

| Physical | | | Comparison | | |
|---|---|---|---|---|---|
| properties | Condition | Unit | Example 3 | Embodiment 3 | Embodiment 4 |
| Fracture | — | % | 1700 | 2150 | 2900 |
| Elongation | | | | | |
| Tensile | — | MPa | 2.6 | 0.8 | 0.4 |
| strength | | | | | |
| Peel strength/ | 0.2 mm thick | N/cm | 17 | 13 | 9 |
| CF rate | | % | 100 | 100 | 100 |
| | 0.3 mm thick | N/cm | 26 | 20 | 12 |
| | | % | 100 | 100 | 100 |
| | 0.5 mm thick | N/cm | 43 | 30 | 17 |
| | | % | 100 | 100 | 100 |
| | 1.0 mm thick | N/cm | 67 | 47 | 25 |
| | | % | 100 | 100 | 100 |
| Hardness | JIS type A | — | 10 | 6 | 5 |
| Inner pressure | 0.3 mm thick | KPa | 12 | 92 | 102 |
| during static | | — | Yes | Yes | No |
| deployment | | | | | |
| tests/gas | | | | | |
| leakage | | | | | |
| Fracture | 0.2 mm thick | N/cm | 70 | 88 | 97 |
| reaching load | 0.3 mm thick | N/cm | 101 | 130 | 147 |
| | 0.5 mm thick | N/cm | 156 | 212 | 249 |
| | 0.7 mm thick | N/cm | 202 | 290 | >353 |

“Fracture elongation” refers to a percentage (%) of an amount of elongation to the original length of a sealing compound at fracture. As shown in Table 2, fracture elongation for Comparison Example 3 is 1700% which are less than 2000%. In contrast, fracture elongation for Embodiment 3 is 2150% and fracture elongation for Embodiment 4 is 2900%, which are set to more than 2000%.

“Tensile strength” refers to a maximum tensile stress (MPa) which acts on a sealing compound at fracture. Tensile strength for Comparison Example 3 is 2.6 MPa, while tensile strength for Embodiment 3 and Embodiment 4 is 0.8 MPa and 0.4 MPa, respectively, which are set to less than 1.0 MPa. As described above, Embodiment 3 and Embodiment 4 according to an exemplary embodiment also have tensile strength set to significantly lower levels than that of the known sealing compounds.

“Peel strength” refers to a force per unit width (N/cm) required to peel off a sealing compound from a base cloth in such a manner that the sealing compound is perpendicular to the surface of the base cloth. In peel tests, a base cloth of a predetermined size (for example, approximately 250 mm by 50 mm) was used as a specimen which was coated with a sealing compound in such a manner that the sealing compound coating had a width of approximately 10 to 15 mm and a predetermined thickness. Such a specimen was mounted on the chuck and was pulled at approximately 200 mm/min. Then, a load at which the sealing compound fractured was measured. At the same time, the CF rate (cohesive fracture rate) was also measured. These tests found that the peel strength of Comparison Example 3 was 17 N/cm, 26 N/cm, 43 N/cm, and 67 N/cm for coating thickness of 0.2 mm, 0.3 mm, 0.5 mm, and 1.0 mm, respectively.

In contrast, the peel strength of Embodiment 3 was 13 N/cm, 20 N/cm, 30 N/cm, and 47 N/cm for coating thicknesses of 0.2 mm, 0.3 mm, 0.5 mm, and 1.0 mm, respectively, while the peel strength of Embodiment 4 was 9 N/cm, 12 N/cm, 17 N/cm, and 25 N/cm. These test results show that greater fracture elongation results in lower peel strength for the same coating thickness of a sealing compound, while smaller coating thickness results in lower peel strength for the same fracture elongation. In view of the fact that an exemplary sealing compound is intended to have a smaller coating thickness and that the known sealing compound has an average coating thickness of approximately 0.5 mm, it is preferable to use a sealing compound having peel strength less than that of Embodiment 3 (30 N/cm) for coating thickness of 0.5 mm. In addition, it is more preferable to use a sealing compound having peel strength lower than that of Embodiment 3 (20 N/cm) for a coating thickness of 0.3 mm. Also, assuming that further smaller coating thickness is possible, a sealing compound having peel strength less than that of Embodiment 3 (13 N/cm) for a coating thickness of 0.2 mm may be used. It was found that CF rate (cohesive fracture rate) was 100% throughout all the tests.

Tensile strength and peel strength described above are physical properties that affect the strength of a sealing compound. In order to have fracture elongation set to more than 2000%, a flexible sealing compound that can withstand the fracture elongation must be prepared by controlling either or both of the physical properties. More specifically, the tensile strength and peel strength must be controlled by repeatedly conducting simulations and tests so as to achieve a sealing compound having a desired coating thickness that can withstand fracture elongation of more than 2000%. The requirements derived from Embodiment 3 and Embodiment 4 described above that tensile strength should be 1.0 MPa or less and that peel strength should be not more than a predetermined value (for example, 30 N/cm, 20 N/cm, 13 N/cm) or less are provided only as an example.

“Hardness” refers to a measurement value obtained on the basis of testing methods pursuant to JIS-K6253 Type A. Since hardness is affected by the magnitude of the tensile strength and peel strength, higher strengths represent being harder, while lower strengths represent being softer. Comparison Example 3 was found to have a hardness of 10, Embodiment 3 was found to have a hardness of 6, and Embodiment 4 was found to have a hardness of 5. These measurement results show that a hardness of less than 10 is preferable.

“Inner pressure during static deployment test” refers to an inner pressure of an airbag measured three seconds after the inflator (gas generator) is initiated. Such a test for inner pressure during a static deployment used the specimen as used in the peel strength measurement, whose sealing compound applied portions are sewn with polyamide sewing threads. The sewing threads have a thread size of 1400 dtex with sewing pitches of 2.0 to 2.3 mm. For “gas leakage”, sealed portions (sewn portions) were inspected for presence of gas leakage at the time of the measurement of the inner pressure during static deployment tests. Comparison Example 3 had an inner pressure of 12 kPa during static deployment tests and suffered from gas leakage. In this Comparison Example 3, gas leakage was present all around the sealed portions, showing that the inner pressure of 12 kPa during static deployment tests is a lower limit. Inner pressure of 12 kPa during static deployment tests for Comparison Example 3 means that the inner pressure maintaining feature as an airbag is lost. In contrast, Embodiment 3 had an inner pressure of 92 kPa during static deployment tests, and Embodiment 4 had an inner pressure of 102 kPa during static deployment tests, showing that the inner pressure maintaining feature as an airbag is sufficiently secured. Although Embodiment 3 suffered from partial gas leakage, it provides satisfactory performance as an airbag because of its ability to maintain inner pressure at 92 kPa during static deployment tests.

The characteristics of the cloth used to form an airbag with the sealing compound may have an effect on the performance of the sealing compound. As shown in FIGS. 4 and 5, Embodiment 3 is shown to have a higher fracture reaching load than Embodiment 2 despite the use of the same sealing compound. This may be due to the difference in magnitude of a gap (created in sewn portions when the base cloth is pulled by sewing threads) resulting from the use of the base cloths having different structures. Embodiment 3 may suffer from partial gas leakage despite its higher fracture reaching load compared to that of Embodiment 2 due to an increase in inner pressure of the airbag resulting from the use of the base cloths having different air tightness.

As shown in Table 2, the known sealing compound (Comparison Example 3) provides an insufficient inner pressure during static deployment tests if the coating thickness thereof is reduced to 0.3 mm, while the exemplary sealing compound (Embodiments 3 and Embodiment 4) can maintain a sufficient inner pressure during static deployment tests even if the coating thickness thereof is reduced to 0.3 mm.

“Fracture reaching load” refers to a load (N/cm) at which the fracture of a sealing compound reaches the sewing threads. The relationship between fracture reaching load and fracture elongation in Comparison Example 3, Embodiment 3, and Embodiment 4 can be represented as shown in FIG. 5. In FIG. 5, consideration of the relationship between fracture elongation and fracture reaching load for each coating thickness d indicates that the fracture elongation is proportional to the fracture reaching load. As shown in the figure, a line can be drawn for each of d=0.2, d=0.3, d=0.5, and d=0.7. Table 2 indicates fracture reaching load of “>353” for Embodiment 4 having a coating thickness of 0.7 mm because the sewing threads fractured before the fracture of the sealing compound reached the sewing threads (in other words, the sewing threads have fracture reaching load of 353 N/cm).

Most average known sealing compounds are those having a coating thickness of 0.5 mm like Comparison Example 3. For the line of d=0.5, fracture reaching load of 154 N/cm can be found if the fracture elongation is 1700%. Also, when fracture reaching load is 154 N/cm, fracture elongation for the line of d=0.3 can be found to be 2800% and fracture elongation for the line of d=0.2 can be found to be 4170%. Accordingly, in order to ensure that a sealing compound having fracture elongation of more than 2000% used in an exemplary embodiment provides the same performance as that of the most average known sealing compounds, its fracture elongation may be set to not less than 2800% and not more than 4170%.

In view of the fact that the known sealing compound typically has a coating thickness d of 0.3 mm or more and that an exemplary sealing compound is intended to have smaller coating thickness, the same performance as the fracture reaching load (93 to 219 N/cm) found from FIG. 5 within the range of coating thickness d between 0.3 and 0.7 mm at fracture elongation (1700%) of Comparison Example 3 is satisfactory for the purpose. Accordingly, it is preferable that a sealing compound for use in an airbag according to an exemplary embodiment is a sealing compound which meets a region (indicated by dark shades) in FIG. 5 where shaded portions in which fracture elongation is more than 2000% and shaded portions in which fracture reaching load is between 93 and 219 N/cm overlap. Although smaller coating thickness d results in better sealing compounds, the coating thickness of not less than 0.2 mm and not more than 0.3 mm is preferable from a practical viewpoint, taking into account the coating process and application accuracy of a sealing compound. However, according to other exemplary embodiments, a sealing compound may have a coating thickness d of less than 0.2 mm.

Fracture elongation and fracture reaching load values found from FIG. 5 described above are values that are variable depending upon experimental value errors, subtraction in approximate formulas or the like, and are not limited to the values described above. Accordingly, in order to ensure that the sealing compound according to an exemplary embodiment provides the same performance as the known sealing compounds, for example, fracture elongation may be set to a range between 2800% and 4200%, and fracture reaching load may be set to a range between 90 and 220 N/cm.

Embodiment 1 and Embodiment 2 described above use a base cloth having a thread size of 470 dtex (decitex) and a weaving density (vertical by horizontal) of 46 by 46 (threads per inch), while Embodiment 3 and Embodiment 4 use a base cloth having a thread size of 235 dtex (decitex) and a weaving density (vertical by horizontal) of 70 by 70 (threads per inch). In other words, Embodiment 1 and Embodiment 2 use a basic cloth woven of thicker threads, while Embodiment 3 and Embodiment 4 use a basic cloth woven of thinner threads. Regardless of whether either base cloth is used, the sealing compound has fracture elongation of more than 2000% and cohesive failure rate of 100%, and similar tendencies are exhibited. Accordingly, the present invention is not limited to the airbags which use base cloth exemplified in the four embodiments described above, but can be applied to airbags which use at least base cloths having a thread size between 235 and 470 dtex (decitex) and a weaving density (vertical by horizontal) between 46 by 46 and 70 by 70 (threads per inch).

Accordingly, judging from the results obtained from the four embodiments described above, it is preferable that the sealing compound has fracture reaching load of not less than 73 N/cm and not more than 219 N/cm and fracture elongation of not less than 2700% and not more than 4170%, considering applications to various base cloths. Also, taking experimental value errors and subtraction in approximate formulas into consideration, the sealing compound may have fracture reaching load of not less than 70 N/cm and not more than 220 N/cm and fracture elongation of not less than 2700% and not more than 4200%.

Furthermore, from the results obtained from the four embodiments described above, it is easily presumable that even base cloths falling outside of the scope of the these four embodiments, such as base cloths having a thread size of less than 235 dtex (decitex), a thread size of more than 470 dtex (decitex), a weaving density (vertical by horizontal) of less than 46 by 46 (threads per inch), or a weaving density (vertical by horizontal) of more than 70 by 70 (threads per inch) exhibit the results similar to those of the four embodiments described above as long as they can be used as a base cloth of an airbag, and an exemplary sealing compound can be applied to these base cloths.

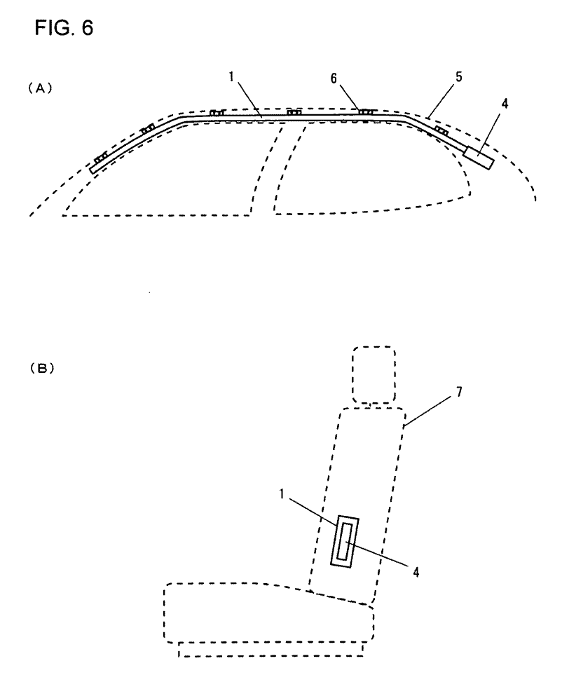

FIG. 6 is a diagram showing an example of an airbag apparatus according to an exemplary embodiment. FIG. 6(A) shows a curtain airbag apparatus. FIG. 6(B) shows a side airbag apparatus.

The airbag apparatus shown in FIGS. 6(A) and 6(B) includes an airbag 1 that is usually in a folded state and inflates and deploys in the event of an emergency and an inflator 4 for supplying gas to the airbag 1. The airbag apparatus as shown in FIG. 6(A) is a curtain airbag apparatus that inflates and deploys the airbag 1 from the upper portion of a vehicle body 5 into a space between the occupant and the vehicle body 5 in the event of a side impact. The airbag of such a curtain airbag apparatus, inserted into, for example, a cylindrically-shaped nonwoven fabric cloth, is disposed at the upper portion of the vehicle body 5 through a plurality of brackets. The airbag apparatus as shown in FIG. 6(B) is a side airbag apparatus that restrains an occupant by inflating and deploying the airbag 1 in the forward direction from the side of a vehicle seat 7 in the event of a side impact. The airbag 1 of such a side airbag apparatus, folded in, for example, a nonwoven fabric cloth, is disposed inside of the vehicle seat 7. The airbag apparatus as shown in FIGS. 6(A) and 6(B) preferably maintains the inner pressure of the airbag 1 for a certain period of time.

The inflator 4 is a gas generator that supplies gas to the airbag 1, and may be disposed in the vehicle body 5 apart from the airbag 1 as shown in FIG. 6(A), or may be wrapped in a nonwoven fabric cloth together with the airbag 1 and be disposed inside of the vehicle seat 7, as shown in FIG. 6(B).

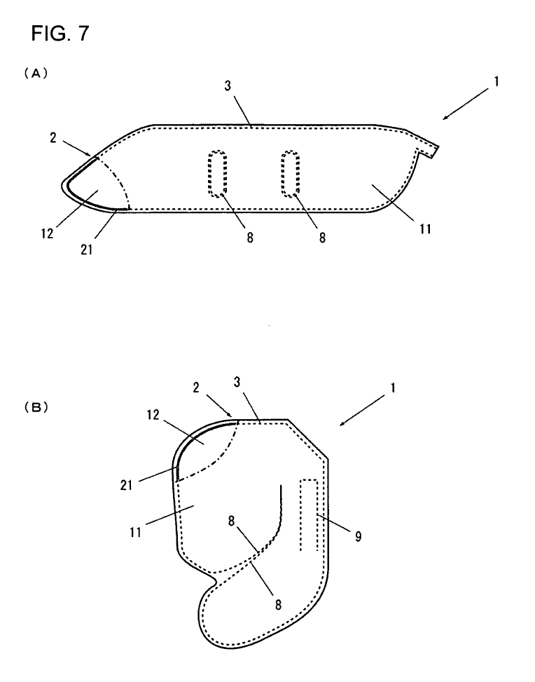

FIG. 7 is a diagram showing an example of an airbag. FIG. 7(A) shows an airbag of a curtain airbag apparatus. FIG. 7(B) shows an airbag of a side airbag apparatus. Portions enclosed by dashed-dotted lines show a state where part of base cloth is cut off.

An airbag as shown in FIG. 7(A) is an airbag for use in the curtain airbag apparatus as shown in FIG. 6(A), showing a planar development of the airbag. An airbag 1 as shown in FIG. 7(B) is an airbag for use in the side airbag apparatus as shown in FIG. 6(B), showing a planar development of the airbag. These airbags 1 are an airbag formed by applying a sealing compound 21 to between base cloths 11, 12 facing each other and sewing the sealing compound 21 applied portions with sewing threads 3 for joining the base cloths 11, 12, wherein the sealing compound 21 has fracture elongation of more than 2000% and cohesive failure rate of 100%. Material for the base cloths 11, 12 is the same as the known airbag (for example, synthetic resin). The faces of the base cloths 11, 12 facing each other may be coated with a silicone rubber. According to an exemplary embodiment, the sealing compound 21 is an exemplary sealing compound 21 as described above.

As is the case with the airbag 1 shown in FIGS. 7(A) and 7(B), above-mentioned sealing compound 21 is typically applied to the outer circumference of the airbag 1, but may also be applied to the sewn portions 8 that divide the airbag 1 into a plurality of chambers or to the sewn portions 9 that house the inflator 4.

According to an exemplary embodiment, the airbag and airbag apparatus as described above have the sealing compound arranged so as to provide fracture elongation of more than 2000%, greater than known sealing compounds, and cohesive failure rate of 100%, thereby allowing a easily stretchy and difficult to peel seal layer to be formed in the airbag which results in a reduction in the coating thickness of the sealing compound. Accordingly, the amount of sealing compound application can be reduced, leading to a reduction in cost and weight of the airbag. In addition, reduced coating thickness of the sealing compound results in a reduction in package volume when the airbag is folded as well as reduced stiffness of sealed portions which can make the airbag easier to fold.

Setting the fracture reaching load of the sealing compound to a predetermined range allows the sealing compound to provide the same features as known sealing compounds. Also, setting the fracture elongation of the sealing compound to a predetermined range allows easy ingredient formulation and easy application of the sealing compound. In addition, setting coating thickness to 0.2 mm to 0.3 mm results in a reduction in coating thickness as compared with known sealing compounds, and easy ingredient formulation and easy application of the sealing compound. Also, even setting the strength (tensile strength or peel strength) of the sealing compound to below a predetermined level can prevent gas leakage. Furthermore, setting the hardness (JIS Type A) of the sealing compound to less than 10 results in flexible sealed portions, which can make the airbag easier to fold.

The priority applications, Japanese Patent Application 2008-283791 filed Nov. 4, 2008 and Japanese Patent Application No. 2009-205218 filed Sep. 4, 2009, are incorporated by reference herein in their entireties.

The above-described curtain airbag apparatus, side airbag apparatus, and airbag 1 for these apparatuses are an exemplary only and are not limited to the structure illustrated herein. In other words, the sealing compound can be applied to various types of airbag apparatuses and airbags for these apparatuses, which include a driver side airbag apparatus disposed in the steering wheel, a passenger side airbag apparatus disposed inside of the instrument panel, a knee airbag apparatus disposed under the dash board, and the like.

The construction and arrangements of the seatbelt apparatus, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. An airbag comprising:
a pair of base cloths;
a sealing compound located between the base cloths, wherein the sealing compound contacts a portion of each of the base cloths;
wherein the base cloths are sewn together at the portions of the base cloths in contact with the sealing compound to thereby join the base cloths together;
wherein the sealing compound has fracture elongation of more than 2000% and the sealing compound has a cohesive failure rate of 100%.

2. The airbag according to claim 1, wherein the sealing compound has fracture reaching load of not less than 73 N/cm and not more than 219 N/cm.

3. The airbag according to claim 2, wherein the sealing compound has fracture reaching load of not less than 73 N/cm and not more than 158 N/cm in the case where the base cloth has a thread size of 470 dtex.

4. The airbag according to claim 2, wherein the sealing compound has fracture reaching load of not less than 93 N/cm and not more than 219 N/cm in the case where the base cloth has a thread size of 235 dtex.

5. The airbag according to claim 1, wherein the sealing compound has fracture elongation of not less than 2700% and not more than 4170%.

6. The airbag according to claim 5, wherein the sealing compound has fracture elongation of not less than 2700% and not more than 3960% in the case where the base cloth has a thread size of 470 dtex.

7. The airbag according to claim 5, wherein the sealing compound has fracture elongation of not less than 2800% and not more than 4170% in the case where the base cloth has a thread size of 235 dtex.

8. The airbag according to claim 1, wherein the sealing compound has coating thickness of not less than 0.2 mm and not more than 0.3 mm.

9. The airbag according to claim 1, wherein the sealing compound has tensile strength of not more than 1.0 MPa or peel strength of not more than 20 N/cm.

10. The airbag according to claim 1, wherein the sealing compound has a hardness (pursuant to JIS Type A) of less than 10.

11. An airbag apparatus, comprising:
an airbag that is normally in a folded state and inflates and deploys in the event of an emergency; and
an inflator for supplying gas to the airbag,
wherein the airbag includes a pair of base cloths and a sealing compound located between the base cloths and wherein the sealing compound contacts a portion of each of the base cloths;
wherein the base cloths are sewn together at the portions of the base cloths in contact with the sealing compound to thereby join the base cloths together;
wherein the sealing compound has fracture elongation of more than 2000% and the sealing compound has a cohesive failure rate of 100%.

12. A method of forming an airbag comprising the steps of:
providing a pair of base cloths;
applying a sealing compound having a fracture elongation of more than 2000% and a cohesive failure rate of 100% to at least a portion of one of the base cloths; and
sewing the base cloths together through the portion of the base cloth applied with the sealing compound to thereby join the base cloths together and form the airbag.

13. The method of claim 12, wherein the step of applying the sealing compound includes applying the sealing compound to both of the base cloths.
